(19) United States
(12) Patent Application Publication
(10) Pub. No.: US 2002/0038248 A1
(43) Pub. Date: Mar. 28, 2002

(54) System and method for providing classified advertisements in a building

(76) Inventors: Scott Mager, New York, NY (US); Jeffrey C. Friedman, New York, NY (US)

Correspondence Address: KILE GOEKJIAN LERNER & REED PLLC, THE EVENING STAR BUILDING, 1101 PENNSYLVANIA AVE, N.W., SUITE 800, WASHINGTON, DC, 20004, US

(21) Appl. No.: 09/960,993

(22) Filed: Sep. 25, 2001

Related U.S. Application Data
(60) Provisional application No. 60/234,759, filed on Sep. 25, 2000.

(51) Int. Cl. G06F 17/60

(52) U.S. Cl. 705/14; 709/217

(57) ABSTRACT

A system and method for providing classified advertisements in a building by providing a portal for a building accessible via the Internet having classified advertisements associated with the portal based upon specific needs of the building. Classified advertisements are received from users of the portal and the users are provided with responses to the classified advertisements. The portal is designed to suit the specific needs of a building.

### CROSS-REFERENCE TO RELATED APPLICATION

This application relates to and claims priority of Provisional Application Ser. No. 60/234,759 filed on Sep. 25, 2000, and entitled “System and Method for Providing Classified Advertisements in a Building.”

### BACKGROUND OF THE INVENTION

1. Field of the Invention

The present invention relates to system and method for providing classified advertisements in a building. More particularly, the invention is directed to distributing classified advertisements in a building using an Internet-based portal for managing the classified advertisements which are directed to tenants in the building.

A classified advertisement is an advertisement generally concerned with offers of or requests for jobs, housing, services, used cars, and the like. Many conventional methods exist for providing classified advertisements, such as newspapers and periodicals.

Similarly, many methods exist for posting and responding to classified advertisements in a particular building. One popular method is through classified advertisements in a tenant-wide newspaper. Some office occupants go to the extent of posting classified advertisements in the break room of their office. The Internet, which includes a very large audience, now provides via the World Wide Web (the “Web”) various methods for users to post, view, and respond to classified advertisements. Further, an intranet connecting clients within the offices of a particular tenant residing in a particular building provides the ability to post classified advertisements to those clients.

Unfortunately, existing methods for posting and responding to classified advertisements in a building do not span the entire community within the building. In particular, an occupant of one tenant office in a building cannot typically view and therefore respond to classified advertisements of the occupants of other tenant offices in the same building. Further, an occupant of one tenant office in a building cannot typically post classified advertisements to the entire community in the same building. Accordingly, there is a need for a way to post and respond to classified advertisements in a particular building.

Furthermore, existing methods for posting a classified advertisement in a particular building do not allow targeting of specific offices or tenants within a particular building. Therefore, it would be desirable to provide a way to post a classified advertisement to a particular audience in a particular building.

Although posting a classified advertisement can usually be accomplished with relative ease, removing the classified advertisement from a posted list is not as easy, and in some cases not possible. For example, in a case in which a seller posts a classified advertisement in a newspaper for a used car. Generally, newspapers charge a certain fee for a fixed period of time to post the advertisement, which is typically in one-week units. If the seller posts the classified advertisement for one week the newspaper will continue to run the classified advertisement even if the seller succeeds in selling the car on the day after posting the classified advertisement. As a result, interested parties may respond to the classified advertisement even if the used car has already been sold. These responses are bothersome and time consuming to the seller. Accordingly, it would be desirable to provide a way to remove a classified advertisement from a posted list.

The Internet, via the World Wide Web (the “Web”), is rapidly replacing most printed methods for providing classified advertisements. Further, intranets within various large companies now provide the ability to post classified advertisements to network clients.

Recent advancements in the Internet have brought, via the Web, a potential to automate many of the manual processes executed daily by people relating to large buildings. In this, a portal is a Web “super-site” providing access to a variety of integrated services including Web searching, news, white and yellow pages directories, e-mail, discussion groups, online shopping and hyperlinks to other Web sites. A portal is the Web equivalent to the original integrated online services such as CompuServe and AOL. Unfortunately, portals in the prior art are not designed to suit the specific needs of providing classified advertisements to tenants of a particular building.

People typically greet the introduction of new technology with a certain level of resistance. For example, introduction of a building network portal to a community of office workers in a building would certainly be met with some resistance. Therefore, it would be advantageous to provide a way to proliferate the use of a building network portal throughout a building.

Accordingly, it would be desirable to provide a system and method for providing classified advertisements to tenants in a building, which streamline the processes of managing the classified advertisements that are directed to the tenants in a building. In this, it would be highly desirable to provide successful integration of such processes with the Web, for example, by means of a portal for a building, which would fundamentally change the way classified advertisements are distributed to tenants in a building, resulting in a highly efficient process and substantial economic savings.

The difficulties, limitations and desires suggested in the preceding are not intended to be exhaustive, but rather are among many which demonstrate that prior art systems and methods for providing classified advertisements in a building will admit to worthwhile improvement.

### OBJECTS OF THE INVENTION

It is, therefore, a general object of the invention to provide a system and method for providing classified advertisements in a building, which streamline the process of managing classified advertising in a building thereby obviating or minimizing difficulties of the type previously described.

It is another general object of the invention to provide a system and method for providing classified advertisements to tenants in a building, which integrate the processes with the Web.

It is a specific object of the invention to provide a system and method for providing classified advertisements in a building using a Web-based portal for a building, resulting in a highly efficient process and substantial economic savings.

It is another specific object of the invention to provide a system and method for providing classified advertisements to tenants in a building network system.

It is yet another specific object of the invention to provide a system and method for providing classified advertisements to tenants in a building which automatically differentiate the tenants in the building.

It is yet another specific object of the invention to provide a building network system for providing classified advertisements to particular tenants in a particular building through a portal designed to suit the specific needs of the building.

It is yet another specific object of the invention to provide a process of using a building network system to create a portal designed to suit the specific needs for providing classified advertisements in a building.

It is yet another specific object of the invention to provide a system and method for providing classified advertisements to tenants in a building by using a Web-based portal to distribute the advertisements to particular tenants in a particular building.

It is another specific object of the invention to provide a system and method for providing classified advertisements in a building which provide the users with means to manage and respond to the advertisements through a Web-based portal.

It is yet another specific object of the invention to provide a system and method for providing classified advertisements in a building which utilizes a computer connected with the Internet.

It is another specific object of the invention to provide a system and method for providing classified advertisements to tenants in a building with a computer system accessible via the Internet.

### SUMMARY OF THE INVENTION

To achieve at least some of the foregoing objects, the invention provides a method for providing classified advertisements in a building by providing a portal for the building accessible via the Internet At least one user is associated with the portal for the building and the user is provided with functionality for one or more of posting, viewing, responding to and removing classified advertisements at the portal via the Internet. Classified advertisements are received from a user and posted at the portal A request to view the posted classified advertisement is received and the posted classified advertisement is provided for viewing by a user of the portal. A response to the posted classified advertisement is received and the response is provided to the user posting the classified advertisement. A request to remove the posted classified advertisement is received from the user posting the classified advertisement and the posted classified advertisement is removed.

A home page is provided for each user of the portal for a building and the user is uniquely identified and has a specific user role with respect to the portal for a building.

Classified advertisement categories are created and classified advertisements are assigned to the categories. Selected classified advertisements from the categories are associated with a home page for each user based upon predetermined criteria for a building. A link to the categories is provided on a home page for each user such that a user selects a classified advertisement from the associated selected classified advertisements via the categories link.

In a preferred embodiment of the invention, the building is a building network.

A system for providing classified advertisements in a building is provided having at least one server accessible via a communications network with a portal for the building accessible by one or more user via the communications network. The server further includes a receiving module operable to receive one or more of posting, viewing, responding to and removing classified advertisements at the portal via the communications network; a transmitting module operable to provide a response to the one or more of posting, viewing, responding to and removing classified advertisements at the portal via the communications network; and a database operable to store a user profile for each of the one or more user of the portal

The portal includes a home page for each of the one or more user of the portal with each user being uniquely identified and having a specific user role with respect to the portal.

In a preferred embodiment of the invention, the building is a building network and the communications network is the Internet.

### DRAWINGS

Other objects and advantages of the present invention will become apparent from the following detailed description of preferred embodiments thereof taken in conjunction with the accompanying drawings, wherein:

FIG. 1 shows schematically a building network system for providing classified advertisements in a building according to a preferred embodiment of the present invention;

FIG. 2A-C are schematic representations of a process for creating a portal for providing classified advertisements in a building according to a preferred embodiment of the present invention;

FIG. 3 is a schematic depiction of a process for accessing a user home page according to a preferred embodiment of the present invention;

FIG. 4 shows a schematic representation of a process for using a portal to post a classified advertisement to a community in a building according to a preferred embodiment of the present invention;

FIG. 5 shows a schematic representation of a process for using a portal to view and respond to classified advertisements of a community in a building according to a preferred embodiment of the present invention; and

FIG. 6 shows a schematic representation of a process for using a portal to remove a posted classified advertisement according to a preferred embodiment of the present invention.

### DETAILED DESCRIPTION

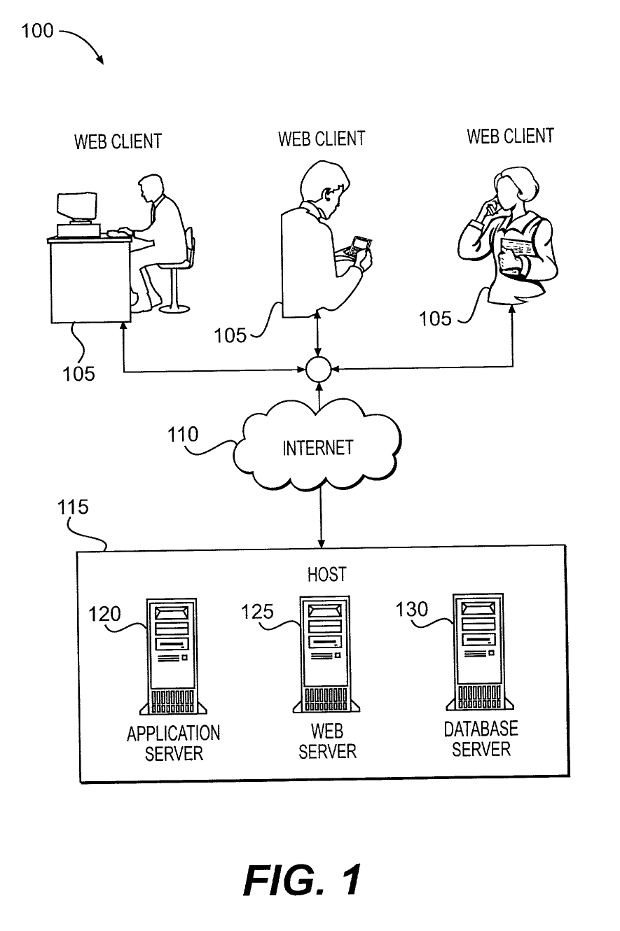

Referring to FIG. 1, a building network system 100, according to a preferred embodiment of the present invention, includes one or more Web clients 105, the Internet 110, and a host 115. Web clients 105 include any conventional system for accessing the Internet, such as a personal computer with a Web browser, personal digital assistant (PDA) including a Web browser, and cellular telephone further including a wireless application protocol (WAP) based browser.

Host 115 further includes elements commonly employed by most internet service providers (ISPs), such as an application server 120, Web server 125, and database server 130. Host 115 further provides a Web-based portal.

As used herein, a portal is a Web “super-site” providing access to a variety of integrated services including, for example, Web searching, news, white and yellow pages directories, e-mail, discussion groups, online shopping and hyperlinks to other Web sites. A portal is the Web equivalent of the original integrated online services such as CompuServe and AOL. Although the term portal initially referred to general-purpose Web sites, it now commonly refers to vertical market Web sites offering related services to a particular industry such as banking, insurance or computers. In this sense, the present invention relates to a portal for a building.

Each user of system 100 falls into a predefined role. Each role provides specific functionality as described below. User roles include, for example, super administrator, building administrator, tenant administrator, office administrator, office user, vendor administrator, vendor user, and anonymous user.

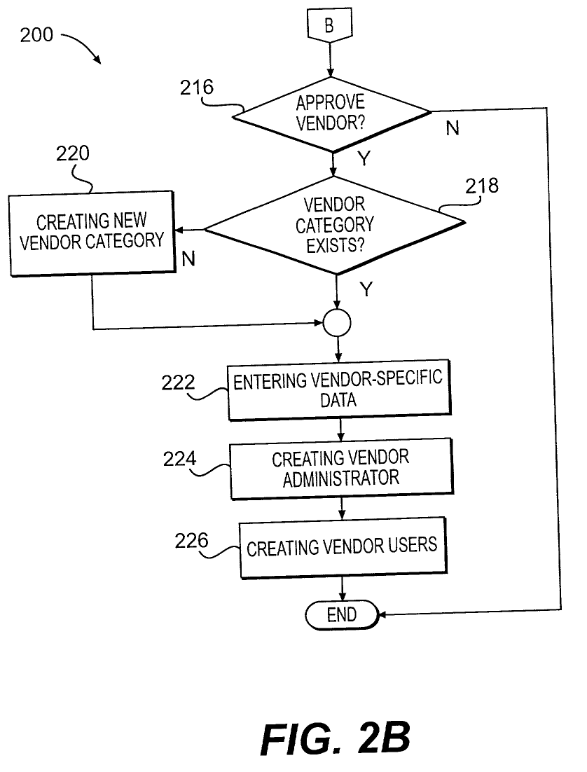

By default, host 115 is configured to allow access of a user corresponding to the anonymous user role through a Web client 105 via the Internet 110. The anonymous user role allows public access to the portal. Host 115 further provides a home page for an anonymous user to access (refer to FIG. 3).

By default, host 115 is configured to allow access of a user corresponding to the super administrator role through a Web client 105 via the Internet 110. In particular, database server 130 contains a user name and password for a super administrator. Host 115 provides a home page for a super administrator to access (refer again to FIG. 3).

Through their home page, a super administrator can perform any function of the system 100 and is responsible for managing all aspects of the system 100. This includes the management of certain aspects of all other users of the system 100. When creating a new user, the super administrator enters data into the database server 130 including the following data elements:

E-mail address (doubles as a user name)

Temporary password (user is asked to pick a new password upon first login to the system)

User role

Password hint

First name

Middle Name/Initial

Last name

Company

Department

Title

E-mail

Home Phone

Work Phone

Mobile Phone

Pager

Fax

Address 1

Address 2

City

State

Zip

Gender

Birth date

Marital Status

Number of children

Income bracket

Education level

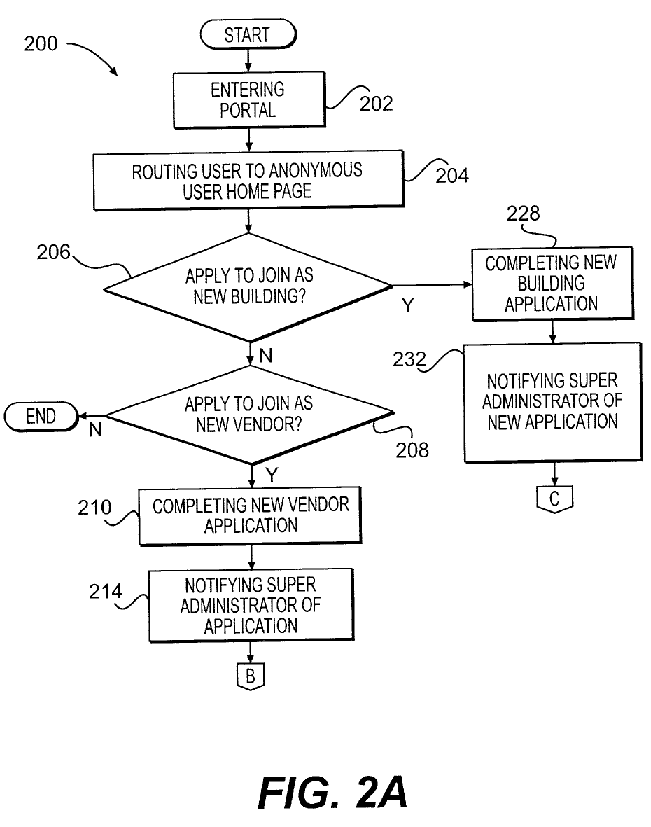

Referring to FIGS. 2 A-C, a process 200 for creating a portal for a building includes:

Step 202: Entering Portal (FIG. 2A)

In step 202 (note FIG. 2A), a user enters the portal residing on host 115 through a Web client 105 and the Internet 110. In particular, a user accesses the portal by entering the uniform resource locator (URL) of the portal into a browser on their Web client 105. By default, host 115 assigns the anonymous user role to the user.

For reasons of simplicity, this step refers to the term portal although the state of the portal is not yet fully built out

Step 204: Routing User to Anonymous User Home Page

In step 204, the user is routed to an anonymous user home page residing on the host 115 via a hyperlink on the portal

Step 206: Apply to Join as New Building?

In step 206, the anonymous user decides whether to join as a new building. If yes, then the process 200 proceeds to step 228; if no, then the process 200 proceeds to step 208.

Step 208: Apply to Join as New Vendor?

In step 208, the anonymous user decides whether to join as a new vendor. if yes, then the process 200 proceeds to step 210; if no, then the process 200 terminates.

Step 210: Completing New Vendor Application

In step 210, the anonymous user completes a new vendor application by entering required data into the fields of an online new vendor application form. The anonymous user enters data into the database server 130 including the following data elements:

Contact Name

Contact Information

Vendor name

Vendor Description

Vendor category

The database server 130 associates a unique identification (ID) code with the data.

Step 214: Notifying Super Administrator of Application

In step 214, the process 200 notifies the super administrator of the application for a new vendor via an e-mail message containing a hyperlink to the portal and the ID code assigned in step 210. The super administrator logs onto the portal as described in connection with FIG. 3 below. From their home page, the super administrator enters the ID code into a text field and submits the ID) code to the host 115. The host 115 then serves a Web page containing the new vendor application data entered in step 210.

Step 216: Approve Vendor? (FIG. 2B)

In step 216 (note FIG. 2B), the super administrator reviews the new vendor application data and decides whether to approve the new vendor. If yes, then the process 200 proceeds to step 218; otherwise, the process 200 terminates. If approved, the super administrator will contact the vendor representative identified in step 210 directly via phone in order to work out any specific details associated with the approval.

Step 218: Vendor Category Exists?

In step 218, the super administrator determines if a vendor category exists for the new vendor. In particular, the super administrator searches the database server 130 to determine if a record containing the appropriate vendor category exists. Vendor categories include those used by users of office buildings, such as food service, limousine service, office supplies, and the like. If no, then the process 200 proceeds to step 220; if yes, then the process 200 proceeds to step 222.

Step 220: Creating New Vendor Category

In step 220, the super administrator creates a new vendor category in the database server 130 corresponding to the new vendor. In particular, the super administrator can add, edit, and remove categories of vendors in the database server 130. All vendors will fall into specific categories (e.g., cleaning service, office supplies, and furniture). Vendor categories affect the way vendors are depicted on-screen and help determine which vendors are appropriate for which buildings. When adding a vendor category, the super administrator enters data into the database server 130 including the following data elements:

Category Name

Category Description

Step 222: Entering Vendor-specific Data

In step 222, the super administrator enters data into the database server 130 including the following vendor-specific data elements:

Name

Vendor Category

Short description

Long description

Address 1

Address 2

City

State

Zip

Main phone number

Primary contact

Primary contact phone number

Optionally, the super administrator can enter data into the database server 130 including the following data elements:

Primary contact e-mail

Primary contact fax

Secondary contact

Secondary contact phone

Secondary contact e-mail

Secondary contact fax

Website URL

Logo

Global specials

Tenant specials

Union status

Step 224: Creating Vendor Administrator

In step 224, the super administrator configures the host 115 to allow access of a user corresponding to the vendor administrator role through a Web client 105 via the Internet 110. In particular, the super administrator creates an e-mail account for a vendor administrator on host 115. The super administrator then stores a user name and temporary password in the database server 130 corresponding to the vendor administrator. The super administrator then sends an e-mail message to the e-mail account of the vendor administrator. The e-mail message contains the temporary password, a hyperlink to the portal, and directions for accessing the new user's home page (refer to FIG. 3).

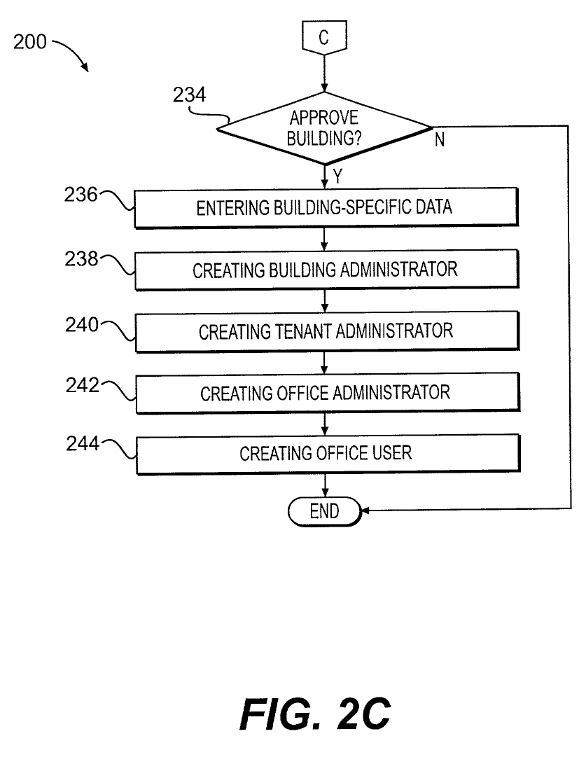

Through their home page, a vendor administrator presents products and services to users of system 100 and manages orders of products and services requested by users of the system 100 as described in connection with FIG. 4 below. In particular, a vendor administrator typically views pending orders, sets the status of orders, and downloads order information in a spreadsheet format. The system 100 allows a vendor administrator to group orders by tenant, building, date, order status, or any combination thereof.

Step 226: Creating Vendor Users

In step 226, the super administrator configures the host 115 to allow access of a user corresponding to the vendor user role through a Web client 105 via the Internet 110. In particular, the super administrator creates an e-mail account for a vendor user on the host 115. The super administrator then stores a user name and temporary password in the database server 130 corresponding to the vendor user. The super administrator then sends an e-mail message to the e-mail account of the vendor user. The e-mail message contains the temporary password, a hyperlink to the portal, and directions for accessing the new user's home page (refer again to FIG. 3).

Through their home page, a vendor user assists the vendor administrator in managing orders requested by users of the system 100 as described below in connection with FIG. 4. In particular, a vendor user has the capability to view pending orders, set order status, and download order information in a spreadsheet format. The configuration of host 115 allows a vendor user to group orders by tenant, building, date, order status, or any combination thereof.

Step 228: Completing New Building Application (FIG. 2A)

In step 228 (note again FIG. 2A), the anonymous user completes a new building application by entering required data into the fields of an online new building application form. An anonymous user requesting to join as a new building would likely be a representative of a building management organization (BMO) or a building owner.

The anonymous user enters data into the database server 130 including the following data elements:

Name

Contact Information

Building name

Building address

Database server 130 associates a unique ID code with the data.

Step 232: Notify Super Administrator of Application

In step 232, the process 200 notifies the super administrator of the application for a new building via an e-mail message containing a hyperlink to the portal and the previously assigned ID code assigned in step 228. The super administrator logs onto the portal as described in connection with FIG. 3. From their home page, the super administrator enters the ID code into a text field and submits the ID code to the host 115. The host 115 then serves a Web page containing the new building application data entered in step 228.

Step 234: Approve building? (FIG. 2C)

In step 234 (note FIG. 2C), the super administrator decides whether to approve the new building. If yes, then the process 200 proceeds to step 236; if no, the process 200 terminates. If approved, the super administrator will contact the building representative identified in step 228 directly via a phone in order to work out any specific details associated with the approval.

Step 236: Entering Building-Specific Data

In step 236, the super administrator enters data into the database server 130 including the following data elements:

Address 1

Address 2

City

State

Zip

Tenants

Company Name

Description

Business Type

In particular, a tenant is an organization that rents space within a building.

Step 238: Creating Building Administrator

In step 238, the super administrator configures the host 115 to allow access of a user corresponding to the building administrator role through a Web client 105 via the Internet 110. In particular, the super administrator creates an e-mail account for a building administrator on the host 115. The super administrator then stores a user name and temporary password in the database server 130 corresponding to the building administrator. The super administrator then sends an e-mail message to the e-mail account of the building administrator. The e-mail message contains the temporary password, a hyperlink to the portal, and directions for accessing the new user's home page (refer to FIG. 3).

Through their home page, a building administrator enters data into the database server 130 including the following building-related data elements:

Address

Name (of the building)

Owner

Photo

Square Feet

Floors

Elevators

Date built

Parking

Hours of operation

Freight hours

Delivery hours

Delivery rules

Rules+Regulations

Work Rules

Work Regulations

Union status

Managing Agent

Name

Address

Phone/Fax

E-mail

Contact

Staff

Building Manager

Assistant Building Manager

Concierge

Engineers

Porters

Fire Safety Director(s)

Leasing Agent

Name

Address

Phone/Fax

E-mail

Contact

Cleaning Contractor

Name

Address

Phone/Fax

E-mail

Contact

Has parking?

Can use roof?

Loading dock

Fire contact

EMS Contact

Police contact

Type of security system

Management company

Available space

Each available space entry must specify the floor number, square footage, and a description of the space.

Vendors

The building administrator selects appropriate vendors from a global collection of vendors in the database server 130 and makes them available to the users in a particular building. By default, all vendors will be available to all users in the building.

A super administrator repeats this step as needed to create additional building administrators.

Step 240: Creating Tenant Administrator

In step 240, the building administrator configures the host 115 to allow access of a user corresponding to the tenant administrator role through a Web client 105 via the Internet 110. In particular, the building administrator creates an e-mail account for a tenant administrator on the host 115. The building administrator then stores a user name and temporary password in the database server 130 corresponding to the tenant administrator. The building administrator then sends an e-mail message to the e-mail account of the tenant administrator. The e-mail message contains the temporary password, a hyperlink to the portal, and directions for accessing the new user's home page (refer to FIG. 3).

Since tenants may span multiple buildings, this role is reserved for a tenant employee who is capable of making corporate-wide (not office-wide) decisions about purchasing, vendor relationships, etc.

A building administrator repeats this step as needed to create additional tenant administrators.

Step 242: Creating Office Administrator

In step 242, the tenant administrator configures the host 115 to allow access of a user corresponding to the office administrator role through a Web client 105 via the Internet 110. In particular, the tenant administrator creates an e-mail account for an office administrator on the host 115. The tenant administrator then stores a user name and temporary password in the database server 130 corresponding to the office administrator. The tenant administrator then sends an e-mail message to the e-mail account of the office administrator. The e-mail message contains the temporary password, a hyperlink to the portal, and directions for accessing the new user's home page (refer to FIG. 3).

Through their home page, an office administrator enters data corresponding to their particular office into the database server 130, including the following data elements:

Contact Information

Facility Manager Contact Information

Purchasing Manager Contact Information

Number of employees

Internet access speed

Number of computers

Fire Warden

Location of office within building

Although a building administrator or tenant administrator can also accomplish this task, it is likely that an office administrator will be in the best position to answer these office-specific questions.

Through their home page, a tenant administrator defines a set of purchasing rules for each office administrator created and stores these rules in the database server 130. For each office administrator created and each vendor the building administrator made available to the building in step 238, the tenant administrator enters data into the database server 130 including the following data elements:

Include hyperlink to vendor's home page on office administrator's home page?

By default, hyperlinks to all of the vendors made available to a particular building will be included on each office administrator's home page.

Maximum purchase amount the office administrator can make without approval.

By default, all office administrators will have the capability to make purchases without approval up to a predetermined amount.

Vendor-specific purchasing rules.

For example, a specific limousine service may only be made available to users after 6:00 PM on weekdays.

Automatic order completion confirmation?

The tenant administrator determines which vendors require order completion confirmation. For limousine service, or food orders, or other services where the tenant administrator's manual confirmation is not necessary, the tenant administrator selects automatic order completion confirmation.

From their home page, an office administrator periodically views a list of all pending orders generated from users within their particular office. The office administrator views orders based on status (pending, completed, delayed, backordered, out-of-stock, unavailable), date of the order, vendor, or the user generating the order. The office administrator can then generate a printable report or download the data in spreadsheet format for further processing in Excel® or a similar application. Refer to FIG. 4.

A tenant administrator repeats this step as needed to create additional office administrators.

Step 244: Creating Office Users

In step 244, the office administrator configures the host 115 to allow access of a user corresponding to the office user role through a Web client 105 via the Internet 110. In particular, the office administrator creates an e-mail account for an office user on the host 115. The office administrator then stores a user name and temporary password in the database server 130 corresponding to the office user. The office administrator then sends an e-mail message to the e-mail account of the office user. The e-mail message contains the temporary password, a hyperlink to the portal, and directions for accessing the new user's home page (refer to FIG. 3).

Through their home page, the office administrator enters data into the database server 130 including the following data elements related to the new office user:

E-mail address

First name

Last name

ID (e.g., birthday, or last 4 digits of social security number)

Through their home page, an office administrator defines a set of purchasing rules for the office user created and stores these rules in the database server 130. For the office user created and each vendor the tenant administrator made available to the office administrator, the office administrator enters data into the database server 130 including the following data elements:

Include hyperlink to vendor's home page on office user's home page?

By default, hyperlinks to all of the vendors made available to a particular building will be included on the office user's home page.

Maximum purchase amount the office user can make without approval.

By default, the office user will have the capability to make purchases without approval up to a predetermined amount.

Vendor-specific purchasing rules.

For example, a specific limousine service may only be made available to users after 6:00 PM on weekdays.

To further facilitate the process of creating purchasing rules for an office user, the system 100 allows an office administrator to create purchasing classes and assign an office user to a specific purchasing class. In particular, the host 115 allows an office administrator to create a new purchasing class and assign a specific set of purchasing rules to that purchasing class. For example, one purchasing class may contain a rule that allows the ordering of limousine service only after 6:00 PM, whereas another purchasing class may contain a rule that allows the ordering of limousine service at any time. This information is stored in the database server 130.

An office administrator repeats this step as needed to create additional office users.

Easy as this may be, it would still be tedious for an office administrator to set up an office of 1,000 employees using this method. Therefore, the system 100 allows an office administrator to automatically create a large group of new users by storing in the database server 130 a file containing a list of e-mail addresses. This data is easily accessible since many offices already have a list of employees in spreadsheet or database format. The database server 130 automatically sends an e-mail message to each e-mail address listed. Each e-mail message contains a unique temporary password and a hyperlink to the portal

Through their home page, an office user orders commercial products and services from any vendor made available to them. In addition, an office user periodically views a list of all pending orders to determine when a particular service has been fulfilled or a product has been delivered. The user's home page further includes a link to functionality for posting, viewing, responding to and removing classified advertisements as described below with reference to FIGS. 4 to 6.

Referring to FIG. 3, a process 300 for accessing a user home page comprises the following steps.

Step 302: Entering Portal

In step 302, a user enters a portal residing on the host 115 through a Web client 105 and the Internet 110. In particular, a user accesses the portal by entering the uniform resource locator (URL) of the portal into the browser on their Web client 105.

Step 304: Logging in as Registered User

In step 304, the process 300 allows a user to register using a predefined user name and password. In particular, the user enters a user name and password into a login Web page on the portal. The host 115 authenticates the user name and password. In the event that a new user attempts to register with a temporary password, host 115 prompts the new user to pick a new password and fill out the remainder of his or her profile.

Step 306: Routine to Proper Home Page

In step 306, the process 300 routes the user to the home page corresponding to the user name of the user entered in step 304. The host 115 automatically creates a new user home page for a new user. A home page may consist of several pages customized specifically for each user.

For example, a user having a role corresponding to an office user would enter a user name and a corresponding password into the appropriate fields within a Web page on the Web client 105. The host 115 then routes the Web browser on the Web client 105 to the home page of the office user.

Referring to FIG. 4, the following describes a process for using a portal to post a classified advertisement to a community in a building. A user executes the process 400 from their home page residing on the portal. FIG. 3 depicts the process 300 for accessing a user home page. Any user of the system can post a classified advertisement as described by process 400. Users having authority to view, respond to and remove posted classified advertisements can do so via their home page at any time during the process 400.

The process 400 comprises the following steps.

Step 402: Selecting Option to Post a Classified Advertisenent

In step 402, a user selects a hyperlink located on the user's home page that links to a classified-advertisement page. Host 115 then links the user's Web browser to the classified-advertisement page within the portal. This Web page includes a link to post a classified advertisement. The user then selects the link to post a classified advertisement. Host 115 then links the user's Web browser to a post-classified-advertisement page.

Step 404: Entering Details of Classified Advertisement

In step 404, the user enters the description of the classified advertisement into a free-form text field on the post-classified-advertisement page. The user further indicates, via pre-defined fields on the post-classified-advertisement page, the category (e.g., auto, sporting goods, miscellaneous items, personal services, employment), the desired posting date and ending date, and the audience of the classified advertisement. In particular, the Web page further includes a selectable list of available audience members. Available audience members include global (posted to the entire Internet community including anonymous users), building-wide (all users within a particular building), tenant-wide (all users of a particular tenant within a particular building), and office-wide (all users in a particular office of a particular tenant within a particular building). The user then clicks the option to submit. Host 115 then stores the detailed data in the database server 130 and associates the email address and user ID of the submitting user with the detailed data.

In the context of the present invention, classified advertisements relate to subjects such as the sale of personal property (e.g., car, concert tickets), personal services (e g., massage given at the office), lost and found (e.g., briefcase found in the corridor on the 4th floor), carpooling, employment, and wanted situations (e.g., seeking workout partner at fitness center in building). Process 400 terminates after step 404.

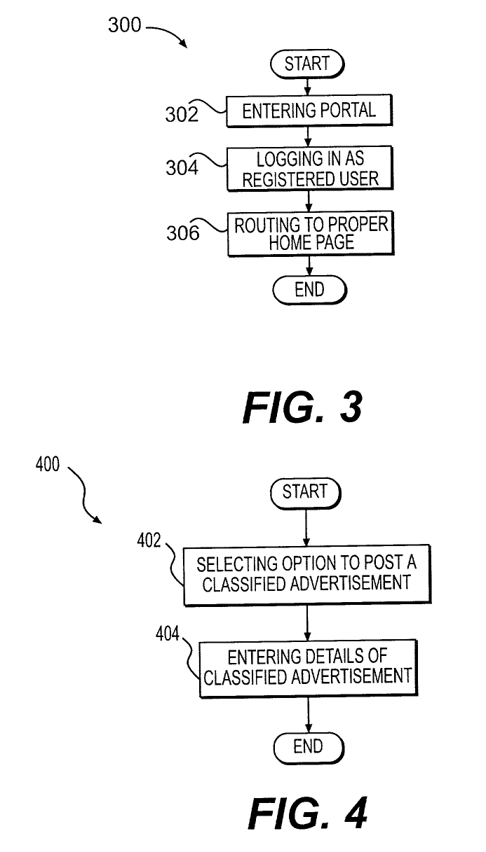

Referring to FIG. 5, the following describes a process for using a portal to view and respond to classified advertisements of a community in a building. A user executes the process 500 from their home page residing on the portal. FIG. 3 depicts the process 300 for accessing a user home page.

The process 500 comprises the following steps.

Step 502: Selecting Option to View Classified Advertisements

In step 502, a user selects a link to the building classified-advertisement page located on the user's home page. Host 115 then links the user's Web browser to the classified-advertisement page within the portal This Web page includes a link to view classified advertisements. The user then selects the link to view classified advertisements. Host 115 then links the user's Web browser to a Web page containing a list of classified advertisements contained in the database 130. Host 115 can further sort and filter the list of classified advertisements by category, date and audience (refer to step 404). Each classified advertisement contains a link to the e-mail address of the submitting party as described in step 404.

Step 504: Responding to a Classified Advertisement

In step 504, the user responds to the classified advertisement selected in step 502 by selecting the link to the submitting party's e-mail address and sending them an appropriate e-mail message. Process 500 terminates after step 504.

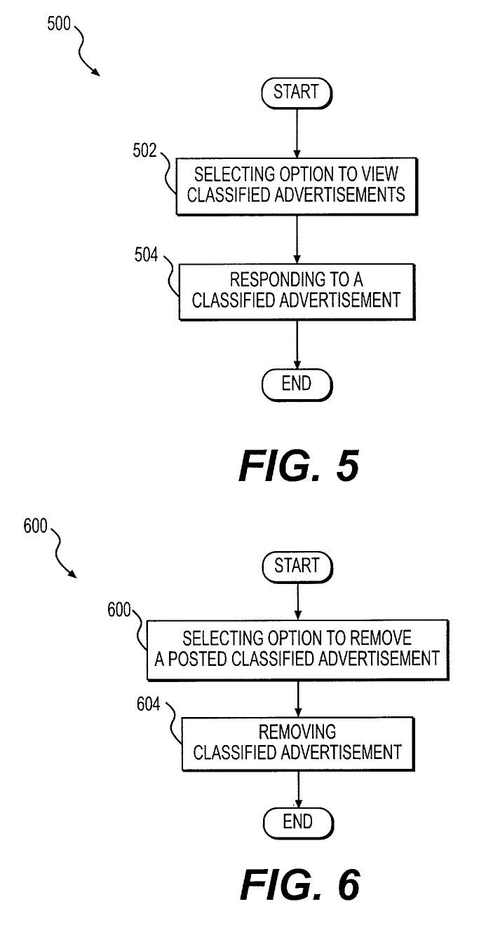

Referring to FIG. 6, the following describes a process for using a portal to remove a posted classified advertisement. A user executes the process 600 from their home page residing on the portal FIG. 3 depicts the process 300 for accessing a user home page.

The process 600 comprises the following steps.

Step 602: Selecting Option to Remove a Posted Classified Advertisement

In step 602, a user selects a link to the building classified-advertisement page located on the user's home page. Host 115 then links the user's Web browser to the classified-advertisement page within the portal This Web page includes a link to remove a posted classified advertisement. The user then selects the link to remove a posted classified advertisement. Host 115 then links the user's Web browser to a Web page containing a list of the user's posted classified advertisements contained in the database 130.

Step 604: Removing Classified Advertisement

In step 604, the user selects the desired classified advertisement to remove, then selects an option to remove the selected advertisement. In particular, host 115 directs the database server 130 to remove the selected classified advertisement from the list of posted classified advertisements. Process 600 terminates after step 604.

Although the above description of the present invention is directed to a network provided in a building, it can be appreciated that the present invention could also be applied to any type of facility such as a hotel, university campus, government complex, airport, shipping port, factory, amusement park, shopping mall or cruise ship. Further, the present invention could also be applied to a geographical area such as a park containing dispersed facilities, and a body of water whereon ships are dispersed.

Summary of Major Advantages of the Invention

After reading and understanding the foregoing description of preferred embodiments of the invention, in conjunction with the illustrative drawings, it will be appreciated that several distinct advantages of the subject system and method for providing classified advertisements in a building are obtained.

One advantage of the present invention is a portal designed to suit the specific needs of providing classified advertisements in a particular building. The portal provides a convenient, integrated location for targeting classified advertisements to tenants in a building.

Another advantage of the present invention is a way to automatically differentiate tenants in a building and particular buildings in a building network

Yet another advantage of the present invention is that it saves time, money, and effort by reducing the time spent in providing classified advertisements to tenants in a building.

Yet another advantage of the present invention is the ability of a community within a building to more efficiently communicate among each other. In particular, since the building is a common place to both parties (seller and buyer), they can easily meet in the building.

Yet another advantage of the present invention is that it promotes the proliferation of the use of a building network portal throughout a building. In particular, the user-friendly functionality inherent to the present invention would help reduce the resistance to the introduction of the building network portal to the occupants in the building. Once timid users become comfortable with the functionality provided by the present invention, they would find it easier to extend into other functionality of the building network portal

Yet another advantage of the present invention is that users can post a classified advertisement to a particular office or tenant within a particular building.

Yet another advantage of the present invention is that users can remove a classified advertisement from a posted list.

Another advantage of the present invention is that an anonymous user of the portal can view classified advertisements from users within a particular building.

Successful development of an Internet-based system and method for providing classified advertising specific to a particular building would provide a value-added and convenient feature to users within the building.

Value-added and convenient features would further complement a portal through which a building owner or manager can promote and sell additional commercial products and services including office supplies, limousine service, messenger service, and upgrade office-cleaning service to tenants within the building. In particular, such a feature would help proliferate use of such a portal throughout a building by attracting various potential users within the building. Familiarizing users with convenient functionality facilitates their transition into other valuable portal functionality.

In accordance with the foregoing, the present invention provides a system and method for providing classified advertisements in a building.

A building is a physical location run by a building management organization (BMO). One building houses many tenants, each tenant occupying one or more unit in the building, and offers the services and products of many vendors.

A portal is a Web “super-site” providing access to a variety of integrated services including, for example, Web searching, news, white and yellow pages directories, e-mail, discussion groups, online shopping and hyperlinks to other Web sites. A portal is the Web equivalent of the original integrated online services such as CompuServe and AOL. Although the term portal initially referred to general-purpose Web sites, it now commonly refers to vertical market Web sites offering related services to a particular industry such as banking, insurance or computers. In this sense, the present invention relates to a portal for a building.

A first aspect of the present invention is a building network system for providing classified advertisements in a building through a portal designed to suit the specific building.

A second aspect of the present invention is a process of using the building network system to create a portal designed to suit a particular building for providing classified advertisements to tenants in the building.

A third aspect of the present invention is a process of using the portal to distribute targeted classified advertisements to tenants in the building.

A fourth aspect of the present invention is a process of managing classified advertisements through the portal.

A fifth aspect of the present invention is carrying out the processes according to the present invention in a computer.

A sixth aspect of the present invention is a computer system capable of carrying out the processes according to the present invention.

In describing the invention, reference has been made to preferred embodiments and illustrative advantages of the invention. Those skilled in the art, however, and familiar with the instant disclosure of the subject invention, may recognize additions, deletions, modifications, substitutions and other changes that fall within the purview of the subject invention.

What is claimed:

1. A method for providing classified advertisements in a building, the method comprising the steps of:
providing a portal for a building accessible via the Internet;
associating at least one user with said portal for the building and providing said at least one user with functionality for one or more of posting, viewing, responding to and removing classified advertisements at said portal via the Internet;
receiving and posting at said portal at least one classified advertisement from a user of said portal;
receiving a request to view said posted classified advertisement and providing said posted classified advertisement for viewing by a user of said portal;
receiving a response to said posted classified advertisement and providing said response to said user posting said classified advertisement;
receiving a request to remove said posted classified advertisement from said user posting said classified advertisement and removing said posted classified advertisement.

2. A method for providing classified advertisements in a building as defined in claim 1, wherein
said step of associating at least one user with said portal for a building includes
the step of providing a home page for each user of said portal for a building; said each user being uniquely identified and having a specific user role with respect to said portal for a building.

3. A method for providing classified advertisements in a building as defined in claim 2, wherein
said step of receiving and posting at said portal at least one classified advertisement includes
the step of creating classified advertisement categories;
assigning classified advertisements to said categories;
associating selected classified advertisements from said categories with a home page for each user based upon predetermined criteria for a building;
providing a link to said categories on a home page for each user such that a user selects a classified advertisement from said associated selected classified advertisements via said categories link.

4. A method for providing classified advertisements in a building as defined in claim 1, wherein
said building is a building network.

5. A method for providing classified advertisements in a building as defined in claim 1, wherein
said step of providing a portal includes
providing a user with access to an anonymous user home page;
determining whether said user is one of a building user and a vendor user;
receiving data input by said user with respect to a user profile;
processing said data to create one of a building user home page and a vendor user home page.

6. A system for providing classified advertisements in a building, the system comprising:
at least one server accessible via a communications network, said at least one server providing a portal for a building accessible by one or more user via said communications network;
said server further including
a receiving module operable to receive one or more of posting, viewing, responding to and removing classified advertisements at said portal via the communications network;
a transmitting module operable to provide a response to said one or more of posting, viewing, responding to and removing classified advertisements at said portal via the communications network, and
a database operable to store a user profile for each of said one or more user of said portal.

7. A system for providing classified advertisements in a building as defined in claim 6, wherein
said portal for a building includes a home page for each of said one or more user of said portal for a building; said each user being uniquely identified and having a specific user role with respect to said portal for a building.

8. A system for providing classified advertisements in a building as defined in claim 6, wherein
said building is a building network and said communications network is the Internet.
